(19) United States
(12) Patent Application Publication
(10) Pub. No.: US 2023/0155842 A1
(43) Pub. Date: May 18, 2023

(54) METHOD AND APPARATUS FOR CERTIFYING AN APPLICATION-SPECIFIC KEY AND FOR REQUESTING SUCH CERTIFICATION

(71) Applicant: Robert Bosch GmbH, Stuttgart (DE)

(72) Inventors: Johannes Ebke, München (DE); Kai Helbig, Leipzig (DE); Christoph Burger-Scheidlin, Muenchen (DE)

(21) Appl. No.: 17/909,487

(22) PCT Filed: Mar. 2, 2021
(86) PCT No.: PCT/DE2021/100209

§ 371 Date: Sep. 6, 2022

(30) Foreign Application Priority Data
Mar. 6, 2020 (DE) 10 2020 202 879.6

(51) Int. Cl. H04L 9/32; H04L 9/30

(52) U.S. Cl. CPC H04L 9/3268; H04L 9/3073; H04L 9/3247

(57) ABSTRACT

The invention relates to a method for certifying an application-specific cryptographic key in a certificate exchange service (30), comprising: receiving (130) a cryptographic attestation certificate (22) for an application-specific public key from an application (20) in an apparatus (10); checking (34; 136) the validity of the attestation certificate (22); and, if the attestation certificate (22) has been recognized as valid, comparing (34; 138) at least some information that has been extracted from the attestation certificate (22) with predefined reference information, and if the comparison reveals that a new certificate should be created, forming (36; 140) a new application-specific certificate (24) that comprises at least the application-specific public key extracted from the attestation certificate (22) and at least some of the information from the attestation certificate; transmitting (150) the new application-specific certificate (24) to the application (20), and to a method for requesting such certification.

### BACKGROUND OF THE INVENTION

The present invention relates to a method for certifying an application-specific key and to a method for requesting such certification, and to a computing unit and to a computer program for performing same.

Encrypted communication is an essential part of modern secure communication. In situations in which previously unknown communication partners meet, encryption is however able to contribute to security only when the identity of the communication partner is able to be guaranteed. If this is not the case, an attacker may insert themselves into the communication chain and thus decrypt and read the communication (man-in-the-middle attacks).

Modern data traffic therefore uses cryptographic certificates in order to identify the communication partner. Such a certificate identifies the owner of a particular cryptographic public key, and thus of the associated key pair. It is possible in principle to validate both partners in a communication using certificates. On the ‘World Wide Web’, however, only the server on the Web is generally validated; no certificate is requested from the clients (that is to say from the browser of the user). Certificates are issued by special, particularly trustworthy authorities, the ‘Certification Authorities’ (CA). Each communication partner trusts certain ones of these trusted authorities and accepts from them any temporally valid certificate that meets certain criteria. Certificates are created in this case on the basis of a request (‘Certificate Signing Request’, CSR) made to the trusted authority or CA. This request comprises data about the person or unit to be authenticated, for example the name. On the basis of these data, the CA performs a corresponding identity check and creates the requested certificate if the check is successful. The certificate contains the public key of the requesting unit, wherein the certificate is usually signed digitally by the trusted authority. The issued certificate may thus indicate that the trusted authority has checked the unit to be authenticated, meaning that all communication partners that trust the trusted authority may consider this check to be successful on the basis of the certificate.

Devices may also be furnished with certificates in this way. For this purpose, the manufacturer of the device has a manufacturer certificate with special authorization to form a trusted authority (local CA), wherein the manufacturer certificate is preferably issued by an existing certification authority (CA). A device certificate and an associated secret key are first of all generated. In this case, various features suitable for identifying a device may be used, for example a serial number. It is normal for the process to be performed locally by the manufacturer during the manufacture of the devices, wherein the secret key is preferably generated directly in the device. The device certificate is then signed by way of the manufacturer certificate and installed on the device, possibly together with the key belonging to the device certificate.

However, in the case of devices that are provided with additional components from third parties (for example retrospectively installed program modules or applications), this results in the problem whereby initially all or none of the applications are able to access this device certificate. There is no additional information as to which application on the device uses the device certificate.

Furthermore, the confidentiality of the secret keys is of paramount importance in all cryptographic systems. A communication partner is then trustworthy only as long as the secret key also remains secret. For this purpose, it is possible for example to use specialized hardware that is intended to guarantee particularly secure storage of the keys. Access control to the keys is important in particular in the case of external additional components, such as external applications (apps), since not every application is able to be trusted to the same extent. For instance, for an application that is able to handle banking transactions, it is for example particularly important that no other application on the device has access to the secret key that is used.

For this purpose, it is possible for example to use a key attestation method. In this case, properties of a generated key or key pair are confirmed through certification. A third party, such as for instance a network service, may then be reassured that a key is stored in a secure hardware module and that only one application has access to the key. In this case, the attestation of the generated key may be performed by a trusted component that generally originates from the manufacturer of the device. This trusted component certifies an exact description of the associated secret key, its access control, its storage in secure hardware, and possibly an “Attestation Challenge” of the network service in an attestation certificate. The certificates issued in this way are however not suitable for acceptance as proof of an identity for external services, since the certificate on the device does not correspond to a local certification authority.

It is furthermore possible for example, as in DE 10 2015 201 599 Al, to implement a system in which a computing apparatus monitors the behaviour of installed program modules, for example external communication and the use of user data. For this purpose, the computing apparatus itself is certified as trustworthy and as functioning correctly by virtue of a certificate for the computing apparatus being requested from a corresponding certification authority. This however requires for example comprehensive inspection mechanisms for the computing unit.

### SUMMARY OF THE INVENTION

The invention proposes a method for certifying an application-specific cryptographic key and a method for requesting such certification, and a computing unit and a computer program for performing same.

The invention provides a simple system for the secure use of in particular retrospectively installed modules and applications. What is proposed in particular here is a method for certifying an application-specific cryptographic key, for example in a certificate exchange service, which method comprises the following steps: receiving a cryptographic attestation certificate for an application-specific public key from an application in an apparatus; checking the validity of the attestation certificate; and, if the attestation certificate has been recognized as valid, comparing at least some information that has been extracted from the attestation certificate with predefined reference information, and if the comparison reveals that a new certificate should be created, forming a new application-specific certificate that comprises at least the application-specific public key extracted from the attestation certificate and at least some of the information from the attestation certificate; and transmitting the new application-specific certificate to the application.

An application may thereby obtain an external certificate for a generated key pair that marks the application as trustworthy for other services. Since only the attestation certificate and no requests or information generated by the application (which is initially not yet identified as secure) are initially used, the issuing of the new certificate is based only on data validated by the device system. The check on the information in the attestation certificate is thus centralized, and it is made possible for the application also to use cloud systems or software packages that do not support any further checking of information in device-specific certificates.

Checking the validity of the attestation certificate may in this case in particular comprise validating an apparatus-specific certificate chain that is linked to the attestation certificate and has been received together with the attestation certificate, wherein the certificate chain comprises one or more intermediate certificates and the last intermediate certificate is signed by a manufacturer certificate of the apparatus, and checking the signature of the last intermediate certificate on the basis of one or more stored manufacturer certificates.

Using the new issued certificate for the application, it is thereby also possible to establish an implicit chain of trust from the application via the certificate exchange service to the manufacturer, which may then be used by all network services that trust the certificate exchange service and validated as far as the certificate of the certificate exchange service. The network services involved in this case only have to trust the certificate exchange service, and do not have to check the chain as far as the manufacturer themselves. The newly issued certificate itself no longer has to be linked explicitly to the device attestation certificate or the manufacturer certificate.

It may furthermore optionally be checked, preferably before the beginning of the validation of the attestation certificate and the checking of the certificate data, whether the attestation certificate has already been received and/or checked at an earlier time, and if this is the case, the result may be transmitted that the attestation certificate has been created at an earlier time. This may involve an application-specific certificate that has already been issued earlier or a message about an invalid check on the data. Likewise, instead of the earlier result, a fault message may also be transmitted or the procedure may be terminated without a message.

It is possible in this case to respectively terminate the certification method or to end it with or without corresponding feedback to the application if the attestation certificate has not been recognized as valid or if the comparison of the extracted information reveals that a new certificate should not be created.

In some exemplary embodiments, one or more key parameters for generating a key pair may furthermore be transmitted to the application in response to a connection setup by an application using the certificate exchange service, wherein the key pair to be generated comprises an application-specific secret key and the application-specific public key.

As an alternative or in addition, a challenge may be transmitted to an application in response to a connection setup by the application. After receiving the attestation certificate, it may then be checked whether the received attestation certificate comprises the transmitted challenge by extracting the challenge from the attestation certificate and validating the challenge with an associated response. If the received attestation certificate does not comprise the transmitted challenge, that is to say no challenge is present or the validation is not able to be performed successfully, the certification method may again be terminated or ended.

Such a challenge makes it possible to guarantee a close temporal relationship between the creation of the attestation certificate in the apparatus and the use of the certificate exchange service, that is to say the creation of a new application-specific certificate. An older attestation certificate that was already issued before the connection was set up may then not contain a valid challenge. It goes without saying that a new, unique challenge may preferably be used in each case for each request.

It is furthermore possible to introduce further information about a temporal validity of the certificate and/or information about one or more network services for which the certificate is able to be used into the new application-specific certificate. Such information may be predefined or be able to be retrieved from a suitable authority, including a remote one. This may be for example data about the licensing of the application, or a restriction of the certificate to some or exactly one service for which the certificate is intended to be valid.

What is also proposed is a method for requesting certification for an application-specific key pair by an application in an apparatus, which method comprises the following steps: generating an application-specific cryptographic key pair that comprises a secret application-specific key and a public application-specific key; obtaining an attestation certificate for the application-specific key pair from an attestation module in the apparatus; transmitting the attestation certificate to a certificate exchange service; obtaining a new application-specific certificate for the key pair from the certificate exchange service, wherein the new application-specific certificate comprises at least the public application-specific key and further information.

Since no additional steps, such as when generating a normal certificate creation request, are required, but rather only the certificates are exchanged, the method is overall far less susceptible to errors and allows the application to be authenticated to other services that have marked the certificate exchange service as trustworthy.

In this case, transmitting the attestation certificate may comprise transmitting a certificate chain, linked to the attestation certificate, to the certificate exchange service, wherein the certificate chain comprises one or more intermediate certificates and the last intermediate certificate is signed by a manufacturer certificate of the apparatus. The manufacturer certificate itself does not have to be transmitted in this case. The request to the certificate exchange service thus also remains relatively small, meaning that no large amounts of data are required, and the method may also be used for example in hardware-based systems having limited resources.

In further embodiments, for example additionally in response to the setup of a connection to the certificate exchange service, key parameters may be received from the certificate exchange service, these then being intended to be used to locally generate the application-specific key pair.

As an alternative or in addition, it is possible, during the connection setup (for example during or after a handshake), to receive a challenge from the certificate exchange service, and to forward this challenge to the attestation module in order to create the attestation certificate for the application-specific key pair.

As soon as a new application-specific certificate has been obtained, this may be stored and used in the future for secure communication with at least one network service. The application may thus be authenticated to any network service that is trusted by the authority that issued the new certificate.

In all variants, the attestation certificate may for example comprise one or more of the following items of information: a unique identifier of the apparatus, a signature of the application, information about the validity of system files of the apparatus, information about the application-specific public key and/or about an associated application-specific secret key. Other data, not cited here, in relation to the apparatus and/or the application and/or the keys that are used, the generation and storage methods for the keys or other information may also likewise be contained in the certificate.

A computing unit according to the invention, for example a processor or a virtual machine in a data-processing apparatus, is designed, in particular in terms of programming, to perform a method according to the invention.

The implementation of a method according to the invention in the form of a computer program or computer program product containing program code for performing all of the method steps is also advantageous, since this entails particularly low costs, in particular when an executing unit is also used for other tasks and is therefore present in any case. Suitable data carriers for providing the computer program are in particular magnetic, optical and electrical memories, such as for example hard disks, flash memories, EEPROMs, DVDs and the like. It is also possible to download a program via computer networks (the Internet, an intranet, etc.).

Further advantages and refinements of the invention will become apparent from the description and the accompanying drawing.

The invention is illustrated schematically in the drawing on the basis of exemplary embodiments and is described below with reference to the drawing.

### BRIEF DESCRIPTION OF THE DRAWINGS

FIG. 1 shows an exemplary system in which various certificates and keys may be created and checked according to exemplary embodiments; and

FIG. 2 shows an exemplary sequence of method steps in one possible embodiment.

### DETAILED DESCRIPTION

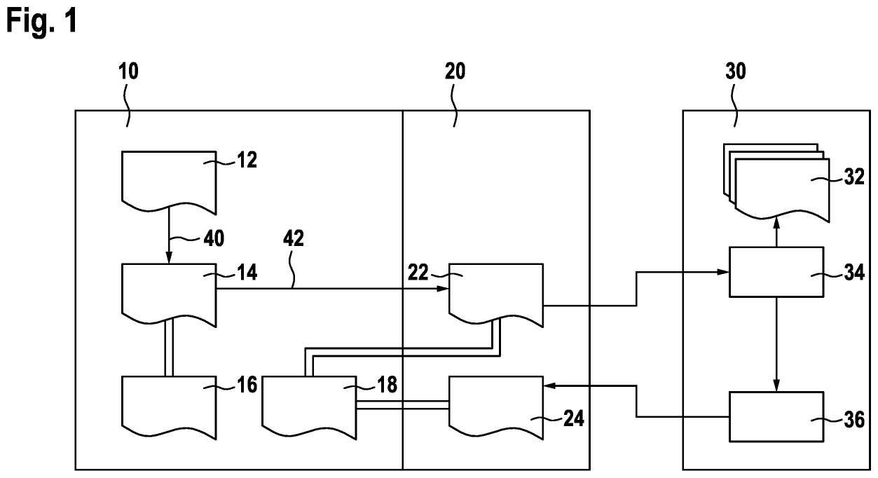

FIG. 1 shows an exemplary system in which various cryptographic certificates may be created and checked according to one exemplary embodiment of the invention.

In this case, an apparatus 10, for example a user terminal, is present and comprises at least one data-processing computing unit, such as for instance a suitable processor and memory elements, and also other elements. The terminal may furthermore comprise communication means that may have, inter alia, a communication interface to other apparatuses in order thereby to transmit and to receive data via suitable protocols. The communication means may be connected to the computing unit, memory elements and other elements. The terminal may thereby for example be incorporated into one or more networks and communicate with services of these networks (not shown).

The apparatus 10 may contain program modules or applications able to be executed by a computing unit, wherein one or more applications 20 may in particular also be present, these having been installed retrospectively on the terminal, that is to say for example as an application installed retrospectively by a user. Such an application 20 should then be certified as being trustworthy and secure for internal and external services, for example for network services communicating with the application. It should thus be possible to guarantee for the services that they are communicating with a special retrospectively installed application that has not been amended or exchanged. The certification may in this case take place specifically in connection with the respective device 10 on which the application 20 is installed. It thus for example additionally becomes possible to assign a device in a network service.

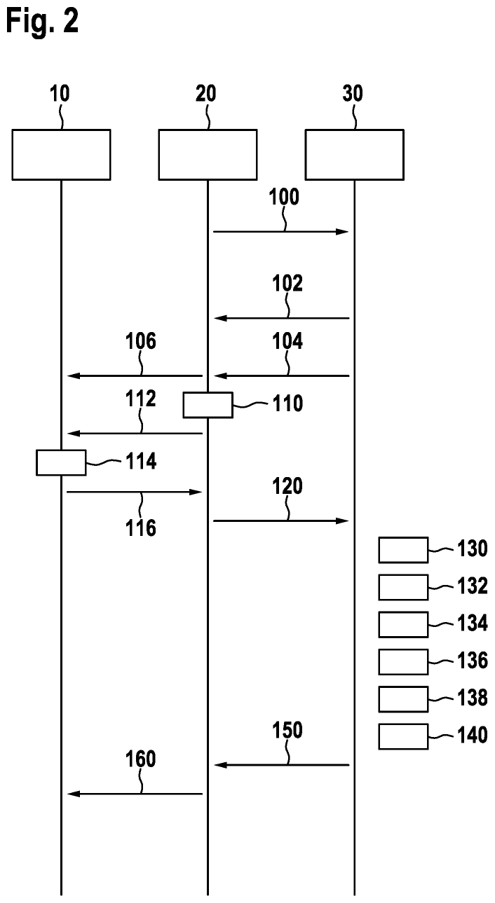

The certification steps according to exemplary embodiments are additionally explained with reference to FIG. 2.

In this case, a manufacturer-dependent manufacturer certificate 12 may initially be present on the apparatus 10, this containing manufacturer-specific information and preferably having already been installed on the apparatus 10 by the manufacturer. The apparatus is furthermore furnished with a secret, device-specific key 16, which may be used to create attestation certificates, and with an associated, device-specific device attestation certificate 14, which contains device-specific information, by the manufacturer. The device attestation certificate 14 may be signed either directly or indirectly, that is to say with further intermediate certificates, by the manufacturer certificate 12, step 40 in FIG. 1, such that a chain of trust consisting of two or more certificates is created, this comprising at least the manufacturer certificate 12 and the device attestation certificate 14 as last certificate in the chain. The manufacturer certificate does not necessarily have to be present on the apparatus in this case, as long as it is present in the certificate exchange service 30 and is able to be identified by a unique identifier.

The application 20 may then generate a cryptographic asymmetric key pair 18 in step 110, for example by using a corresponding interface with the device that is capable of generating such keys, for example the ‘Android KeyStore API’ or another suitable key generation module that is implemented on the device. The application may then request attestation of the generated key pair from the device in step 112, such that a corresponding module on the device issues an attestation certificate 22 for the application-specific key in step 114 and signs it with the device attestation certificate 14, step 42. The attestation certificate 22 for the application-specific key thus contains at least the public key of the application-specific key pair and various information about the identification of the key and/or of the device. The attestation certificate 22 thus generated for the application-specific key is thereby also incorporated into the chain of trust. The associated secret application-specific key 18 is stored in an appropriate manner on the device 10 by the application and/or the key generation module.

This attestation certificate 22, generated in the device, for the application-specific key may then be forwarded to the application (step 116) and transmitted from the application to a certificate exchange service 30 in step 120, for example using appropriate wireless or wired communication means, and optionally also interposed networks. This certificate exchange service 30 may form a trusted authority, in a manner similar to a CA, which is able to create and sign application-specific certificates. The certificate exchange service should contain at least trusted certificates 32 of multiple different manufacturers and/or devices and further information required for validation 34.

If the certificate exchange service 30 obtains the attestation certificate 22 for the application-specific key in step 130, it may check its signature chain in step 136. For this purpose, the application may preferably transmit each certificate in the chain to the certificate exchange service in order to check the entire chain. The data transmission 120 from the application to the certificate exchange service may thus comprise, in order to validate the entire chain, the attestation certificate 22, the device attestation certificate 14 below it and optionally further intermediate certificates in a chain of trust above the manufacturer certificate. In this case, preferably no further information other than the certificates is transmitted, wherein the manufacturer certificate 12 itself is also normally not transmitted. The manufacturer certificates are present in the certificate exchange service as some of the trusted certificates 32 and thus make it possible to check the last certificate or intermediate certificate in the chain that has been signed by the manufacturer certificate.

The transmitting application 20 may in this case optionally sign the data transmission 120, that is to say the transmitted certificates, with its own communication key and/or cryptographically encrypt same. Conversely, the application should in particular be capable of correctly identifying the certificate exchange service. In addition or as an alternative, the attestation certificate 22 for the application-specific keys, which was created and signed by the corresponding attestation module of the device for the application-specific keys, may include information about the application 20 that generated the attested keys and requested the attestation certificate.

If it is identified, in the check 34, 136 on the certificates, that at least one certificate in the chain is not valid and/or that the manufacturer certificate is not able to be validated, the check on the certificate chain may be considered to have failed. In this case, for example, processing of the transmitted attestation certificate may be terminated and a message may optionally additionally be transmitted to the transmitting application 20 specifying that a valid certificate chain is not present. The appropriate manufacturer certificate from the trusted certificates 32 may in this case uniquely identify the manufacturer.

If on the other hand the certificate chain between the attestation certificate and the manufacturer certificate was successfully validated in this checking step 136, various information may then be extracted from the transmitted attestation certificate by the certificate exchange service 30. In this case, it is possible first of all to extract relevant information that may be used to check, in step 138, whether the transmitting application 20 and/or the device 10 that is used are trustworthy. The certificate exchange service may in this case specify which information should be used for this check 138. It is also possible to specify information that should be used only optionally for the check, and the validation of which may also be omitted. Examples of information that may be extracted from the attestation certificate and checked are for instance a serial number or another identifier for uniquely identifying a device; an (as far as possible manipulation-proof) identifier for uniquely identifying for example a certain version of an application; information about system files of the device, for example information about whether a predefined group of system files is unchanged and undamaged (Verified Boot); and the like. This information may be compared with information that is stored in the certificate exchange service 30 or that is retrieved therefrom by another authority in order to validate it. The application-specific public key may furthermore be extracted from the attestation certificate. It goes without saying here that the information does not necessarily have to be extracted from the certificate in this order. It is possible for example to extract the key only when the previous comparison with the information from the attestation certificate was successful, or alternatively to extract the key prior to the check, already with the other information.

If the validation 138 or the comparison with the information from the attestation certificate was successful, a new certificate may be created 36 in step 140. Further information in addition to the information from the attestation certificate may also be evaluated in this case, this further information being present in the certificate exchange service 30, for example information about the application 20 that requests the certificate. By way of example, the certificate exchange service may have available licence information that specifies whether a valid licence has been procured for this application and also optionally the length of time for which this licence is valid. Using this information, it is then possible to restrict a certificate 24 created by the certificate exchange service to the validity of the licence or for example to completely prevent the certificate from being issued if a valid licence is not present.

The certificate exchange service that issues the new application-specific certificate may furthermore also alternatively or additionally locally store such licensing data and, on this basis, for example keep a list or data able to be retrieved in some other way for a network service, specifying whether an already issued new certificate is still valid. It is thereby possible for example to provide changed licence data (licenses not paid for, revocation for other reasons), such that a service is able to check, before the certificate is used, whether the certificate exchange service specifies that the certificate is no longer valid or should no longer be used.

If the check 138 on the data was not successful, the process may again be terminated and/or terminated with a corresponding error message to the requesting application.

Otherwise, the certificate exchange service may then create the new application-specific certificate 24 in step 140 and sign it with its own secret key that is provided for the certification. The new application-specific certificate 24 in this case contains the public application-specific key and further relevant information. This may be for example the checked information from the attestation certificate 22, or all information that was contained in the attestation certificate or only some thereof. Further information may also be incorporated into the application-specific certificate, which information is present for the certificate exchange, for example a validity period on the basis of the licence data described above. It may likewise be specified that the certificate is valid only for communication with one or more particular network services.

The certificate exchange service may then transmit the new application-specific certificate 24 to the application 20 in step 150. The application 20 may then store this certificate together with the associated application-specific secret key 18 in step 160 and use the certificate 24 in the future for mutual authentication with services that trust the certificate exchange service. If the application-specific certificate 24 is limited to certain services, the application may also select the respective certificate suitable for a service from a group of stored certificates. For this purpose, the application 20 and/or the device 10 may store the certificate 24 in suitable storage modules.

Generally speaking, the certificate exchange service 30 may store a specification that specifies which data should be retrieved from the attestation certificate and which data should be integrated into a new application-specific certificate 24. This specification may also optionally be changed by another authority and/or be different for different applications.

The certificate exchange service may optionally, at the beginning of the method, that is to say after obtaining 130 the attestation certificate for the application-specific key, also perform a check, in an additional step 134, as to whether an identical certificate has already been sent previously. For this purpose, the certificate exchange service may for example suitably store all previous attestation certificates obtained for the exchange locally or in another manner such that they are able to be retrieved, such that a comparison is possible. In this case, only a single one or a few data elements of the attestation certificate may initially also be compared. If the check reveals that an identical certificate has already been obtained earlier, it may be defined that for example the old result (for example an application certificate issued in response or a message about an invalid certificate chain) is transmitted back to the application that sent the attestation certificate. As an alternative, an error message may also be output and sent to the application.

In a further exemplary embodiment, additional steps may be implemented. The certificate exchange service 30 may in this case for example additionally use a method such as a challenge-response method, such that a corresponding challenge is transmitted to the application in step 104 and/or certain key parameters are transmitted to the application in step 102 during the setup of the connection between the device and the certificate exchange service. The application, as in the previous exemplary embodiment (step 110), may then create an application-specific key pair, wherein the key parameters used by the certificate exchange service or some thereof may possibly be used to generate the keys. In response, likewise as in the previous example, in step 114, an attestation certificate may be issued by the device for the generated keys, which attestation certificate should additionally contain the obtained challenge. The attestation certificate thereby created may then be transmitted to the certificate exchange service again in steps 116, 120, where the challenge is validated in step 132. Any suitable challenges known to a person skilled in the art are possible as a challenge here. If the challenge is checked successfully, the attestation certificate may be further checked and the new certificate may be issued as described above according to the following steps 134 to 150. Transmitting the challenge 104 during the connection setup 100 (for example in a handshake), this challenge being included in the attestation certificate, guarantees that a temporal relationship between the key generation and/or the creation 114 of the attestation certificate and the creation 140 of a new application-specific certificate is complied with.

The described concept and all of the embodiments are able to be used with apparatuses or terminals of a user, such as for instance smartphones, tablets, computers, but also with other devices that have a communication interface and require an option for secure communication, such as for instance smart home devices or “Internet of Things” (IoT), networked vehicles, and many more.

An application in the industrial context is also conceivable, where production machines, manufacturing apparatuses, robots, partly autonomous systems and other units are increasingly being locally or globally networked and are able to be expanded subsequently by additional applications from the manufacturer or provided by the end consumer itself.

It goes without saying that all of the described variants have been illustrated only as examples and these could be supplemented inter alia by further method steps or individual method steps could also be omitted. The various exemplary embodiments and in particular their individual components and method steps may likewise also be combined with one another.

1. A method for certifying an application-specific cryptographic key in a certificate exchange service (30), the method comprising:
receiving (130) a cryptographic attestation certificate (22) for an application-specific public key from an application (20) in an apparatus (10);
checking (34; 136) the validity of the attestation certificate (22); and,
if the attestation certificate (22) has been recognized as valid, comparing (34; 138) at least some information that has been extracted from the attestation certificate (22) with predefined reference information, and
if the comparison reveals that a new certificate should be created, forming (36; 140) a new application-specific certificate (24) that comprises at least the application-specific public key extracted from the attestation certificate (22) and at least some of the information from the attestation certificate; and transmitting (150) the new application-specific certificate (24) to the application (20) in the apparatus (10).

2. The method according to claim 1, wherein checking the validity (34; 136) of the attestation certificate comprises:
validating an apparatus-specific certificate chain (14) that is linked to the attestation certificate (22) and has been received together with the attestation certificate, wherein the certificate chain comprises one or more intermediate certificates and the last intermediate certificate is signed by a manufacturer certificate (12) of the apparatus, and
checking the signature of the last intermediate certificate on the basis of one or more stored, trusted certificates (32).

3. The method according to claim 1, furthermore comprising:
checking (134) whether the attestation certificate (22) has already been received and/or checked at an earlier time, and if this is the case,
transmitting the result that the attestation certificate has been created at an earlier time.

4. The method according to claim 1, furthermore comprising:
ending the certification method if the attestation certificate (22) has not been recognized as valid (136) or if the comparison (138) of the extracted information reveals that a new certificate should not be created.

5. The method according to claim 1, furthermore comprising:
in response to a connection setup (100) by an application (20), transmitting (102) key parameters for generating a key pair that comprises an application-specific secret key and the application-specific public key to the application (20).

6. The method according to claim 1, furthermore comprising:
transmitting (104) a challenge to the application (20) in response to a connection setup (100) by the application;
and after receiving (130) the attestation certificate (22), checking (132) whether the received attestation certificate (22) comprises the transmitted challenge, by extracting the challenge and validating the challenge with an associated response, and ending the certification method if the received attestation certificate does not comprise the transmitted challenge.

7. The method for requesting certification for an application-specific key pair by an application (20) in an apparatus (10), comprising:
generating (110) an application-specific cryptographic key pair that comprises a secret application-specific key (18) and a public application-specific key;
obtaining (116) an attestation certificate (22) for the application-specific key pair from an attestation module in the apparatus (10);
transmitting (120) the attestation certificate (22) to a certificate exchange service (30);
obtaining (150) a new application-specific certificate (24) for the key pair from the certificate exchange service, wherein the new application-specific certificate (24) comprises at least the public application-specific key and further information.

8. The method according to claim 7, wherein transmitting (120) the attestation certificate furthermore comprises:
transmitting a certificate chain, linked to the attestation certificate, to the certificate exchange service, wherein the certificate chain comprises one or more intermediate certificates (14) and the last intermediate certificate is signed by a manufacturer certificate (12) of the apparatus (10).

9. The method according to claim 7 furthermore comprising:
receiving (102) key parameters from the certificate exchange service (30) in response to the setup of a connection (100) to the certificate exchange service (30); and
using the key parameters to generate the application-specific key pair.

10. The method according to claim 7, furthermore comprising:
receiving (104) a challenge from the certificate exchange service (30) in response to the setup of a connection to the certificate exchange service, and
forwarding (106) the challenge to the attestation module in order to create the attestation certificate (22) for the application-specific key pair.

11. The method according to claim 7, furthermore comprising:
using the new application-specific certificate (24) for secure communication with at least one network service.

12. The method according to claim 1, wherein the attestation certificate (22) comprises one or more of the following items of information:
a unique identifier of the apparatus (10), an identifier for uniquely identifying a particular version of the application (20), information about the application (20), information about the validity of system files of the apparatus, information about the application-specific public key and/or about an associated application-specific secret key (18).

13. The method according to claim 1, wherein the new application-specific certificate (24) furthermore comprises information about a temporal validity of the certificate on the basis of further information in relation to the application and/or information about one or more network services for which the certificate (24) is able to be used.

14. (canceled)

15. (canceled)

16. A non-transitory, computer readable storage medium containing instructions that when executed by a computer causes the computer to certify an application-specific cryptographic key in a certificate exchange service (30), by:
receiving (130) a cryptographic attestation certificate (22) for an application-specific public key from an application (20) in an apparatus (10);
checking (34; 136) the validity of the attestation certificate (22); and,
if the attestation certificate (22) has been recognized as valid, comparing (34; 138) at least some information that has been extracted from the attestation certificate (22) with predefined reference information, and
if the comparison reveals that a new certificate should be created, forming (36; 140) a new application-specific certificate (24) that comprises at least the application-specific public key extracted from the attestation certificate (22) and at least some of the information from the attestation certificate; and transmitting (150) the new application-specific certificate (24) to the application (20) in the apparatus (10).
